(19) United States
(12) Patent Application Publication
(10) Pub. No.: US 2003/0132725 A1
(43) Pub. Date: Jul. 17, 2003

(54) Controller for motor driven device

(75) Inventor: Wai Kuen Cheung, Chai Wan (HK)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Defond Manufacturing Limited, Chai Wan (SG)

(21) Appl. No.: 10/052,235

(22) Filed: Jan. 16, 2002

(51) Int. Cl. H02P 1/00; H02P 1/22; H02P 1/40; H02P 3/00; H02P 3/20; H02P 5/00; H02P 7/00

(52) U.S. Cl. 318/280

(57) ABSTRACT

According to the invention, a controller for a motor driven device is disclosed. The controller for the motor driven device having a motor that draws a current from a power supply to induce a forward motion in response to a load. The controller is conveniently coupled to the device for connection to the motor and for detecting a motor parameter indicative of the value of the load and for pulsing the current “on” and “off” at a predetermined cycle frequency when the value of the motor parameter exceeds a predetermined value for a predetermined period wherein each “on” cycle of the predetermined cycle frequency preferably is of sufficient duration to allow the motor to draw sufficient current in response to the load. Further, each “on” cycle of the predetermined cycle frequency is of sufficient duration to maintain sufficient current to the motor to normalize the forward motion.

### BACKGROUND OF THE INVENTION

The present invention relates to motor driven devices, such as electric power tools and electric food processors, which may be electric motor driven screw driver, drill, mixer, blender, grinder and the like. In particular, the invention relates to a method of controlling such devices in response to a load having been detected and also to a controller and a motor driven device implementing the method.

Electric motor driven devices typically comprise a motor that draws a current from a power supply to induce a forward motion to the motor in response to a load which mainly consists of an external load component. In operating the motor driven devices, the motor may encounter an unexpected large external load component which may cause the motor to stall. Further, a large load could also draw an unexpected large current from the power supply and in the case of an electric reservoir with a limited DC source, for example a battery pack, the electric reservoir may be depleted relatively quickly or sooner over time if electric power is allowed to be drawn freely without restriction or exercise of control. Separately, the motor could also draw an unexpected large voltage or wattage in response to a large load and continuous operation of the motor under these overload or stressful or similar conditions may cause the motor to burnt-out or otherwise may shorten the working life of the motor.

Various methods of detecting and appropriately responding to these overload or stall or similar conditions had been proposed in the past in U.S. Pat. Nos. 4,249,117, 4,267,914, 4,306,264 and EP 0,808,011. Various motor parameters such as current, voltage and even heat value or their rate of change may be detected. Further, the power supply connected to the motor may be temporarily disconnected, and in EP 0,808,011 there was disclosed a method comprising pulsing the motor a plurality of times to deliver a series of torque pulses having peak torque substantially greater than the average torque delivered during the series, which is aimed to overcome the stall condition by imparting greater torque and primarily suitable for a motor powered by alternating current.

### BRIEF DESCRIPTION OF THE DRAWINGS

The present invention is described in conjunction with the appended figures:

FIG. 1 is a simplified block diagram illustrating one embodiment of a controller of the invention;

FIG. 2 is a flowchart illustrating a preferred embodiment of the invention;

FIG. 3 is a graph of motor current as a function of time illustrating the normal operation of a motor without control of the invention; and

FIG. 4 is a graph of motor current as a function of time illustrating the improved operation of a motor with control of the invention.

In the appended figures, similar components and/or features may have the same reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

One embodiment of the present invention provides an alternate method to respond to the overload or stall or similar conditions. In accordance with one feature of an embodiment of the invention, there is provided a method of controlling a motor driven device having a motor that draws a current from a power supply to induce a forward motion in response to a load. The method comprises detecting a motor parameter indicative of the value of the load, and pulsing the current “on” and “off” at a first predetermined cycle frequency when the value of the motor parameter exceeds a first predetermined value for a first predetermined period wherein each “on” cycle of the first predetermined cycle frequency preferably is of sufficient duration to allow the motor to draw sufficient current in response to the load.

In accordance with another feature of an embodiment of the invention, there is provided a controller for a motor driven device having a motor that draws a current from a power supply to induce a forward motion in response to a load. The controller is conveniently adapted to be connected to the motor and to detect a motor parameter indicative of the value of the load. The controller is further adapted to pulse the current “on” and “off” at a first predetermined cycle frequency when the value of the motor parameter exceeds a first predetermined value for a first predetermined period wherein each “on” cycle of the first predetermined cycle frequency is of sufficient duration to allow the motor to draw sufficient current in response to the load in one embodiment.

In one embodiment, each “on” cycle of the first predetermined cycle frequency is of sufficient duration to maintain sufficient current to the motor to normalize the forward motion. Incidentally, each “off” cycle of the first predetermined cycle frequency is of sufficient duration to allow the motor to be substantially released from the forward motion. In practice, the current is pulsed “on” and “off” for a first predetermined duration or alternatively, the current is pulsed “on” and “off” until the current is re-set by manually cutting off the power supply to the motor.

In accordance with further features of various embodiments of the invention, there is provided a controller for a motor driven device having a motor that draws a current from a power supply to induce a forward motion in response to a load. The controller is conveniently adapted to be connected to the motor and to detect a motor parameter indicative of the value of the load. The controller is further adapted to release the motor from the forward motion and induce the motor to a reverse motion for a second predetermined duration when the value of the motor parameter exceeds a second predetermined value for a second predetermined period. Where an embodiment of the power supply is a limited DC source, the invention provides further advantages.

The present invention will be described in details, and generally with reference to an electric motor driven device which may be an electric power screwdriver or power drill and which would have a motor that draws a current from a power supply to induce a forward motion in response to a load.

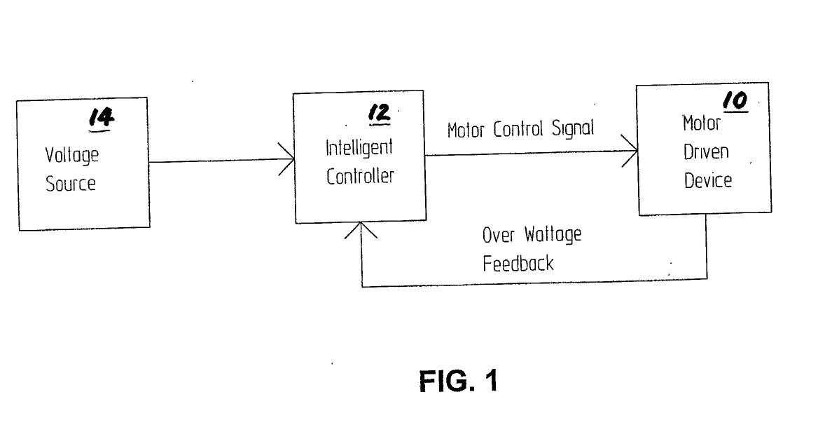

Referring to FIG. 1, an intelligent controller 12 is provided as a separate accessory for a motor driven device 10. In practice, the controller may be formed as a component or part of the motor driven device. The controller 12 is coupled to the motor driven device 10 for connection to a motor (not shown) within the motor driven device. The motor driven device 10 is coupled to a separate voltage source or power supply 14 via the controller 12. In this way, the motor may draw a current from the voltage source 14 to induce a forward motion to the motor in response to a load.

During normal operation of the motor driven device, the motor has an uninterrupted forward motion and the controller periodically or continuously detects a motor parameter indicative of the value of the load by means of receiving a wattage feedback from the motor. The motor parameter may also be the current drawn by the motor in response to the load, or conveniently may be the voltage drop across the motor. When the value of the motor parameter exceeds a threshold or predetermined value and lasts for predetermined period of time, an over wattage feedback would be received by the controller which outputs a motor control signal to the motor and the motor enters into an improved operation mode.

During the improved operation, the motor is controlled in accordance with the invention. In a first aspect, the controller 12 is able to pulse the current “on” and “off” at a first predetermined cycle frequency wherein each “on” cycle of the cycle frequency preferably is of sufficient duration to allow the motor to draw sufficient current in response to the load. Such controller is particularly suitable for a power screwdriver.

For example, when the motor driving a screw, the load encountered by the motor increases as the screw becomes tightened and difficult to turn, and also causes the forward motion of the motor to slow down. The increase of the load may cause an over wattage feedback to the controller. The controller provides a suitable pulsing action to the screwdriver which tightens the screw with each “on” cycle. Further, as the duration of each “on” cycle is chosen to be sufficient to allow the current, which has been disconnected or interrupted during each “off” cycle, to reach its normal operating value in response to the load, overall there is no apparent or any significant adverse effect to the operation of the motor.

The “on” and “off” cycle enables a saving of power consumption from the voltage source, especially for a battery or battery pack or a limited DC power source, this controlled improved operation of the motor may allow the battery to last longer without wasting electric power during operation under high load connections. In one embodiment, the cycle frequency may range from 0.1 second to 13 seconds and for power tools, it is preferable to be set between 0.3 second to 1 second.

More specifically, the duration of each “on” cycle of the cycle frequency would ideally be sufficient to maintain sufficient current to the motor to normalize the forward motion; that is to maintain the normal operation current to the motor for an appropriate operation period. The pulsing operation may be pre-set to last a predetermined duration, or alternatively until the controller or the current is re-set by manually switching off the current thus cutting off the power supply to the motor.

Separately, in other power tools, it would be appropriate to have the duration of each “off” cycle of the cycle frequency being sufficient to allow the motor to be substantially released from the forward motion; that is a longer interruption of the normal operation current is preferred such that the motor may be released of the load.

In a second aspect of the improved operation, which is particularly suitable for a power drill or saw, the current is interrupted to release the motor from the forward motion and the controller further induces the motor to a reverse motion and for a second predetermined duration. It would be appreciated that when the drill or saw becomes jammed or locked between drilling or sawing materials, the motor would encounter an unexpected large load and may become stall. In these impasse conditions, it is preferable to reverse the normal operation or forward motion of the motor, therefore the load is released and the power tool may be un-jammed or un-locked.

Similar to the first aspect, the second aspect of the improved operation also provides additional advantages where the power supply is a limited DC source. Further, besides the saving of battery power resources, both the “on” and “off” pulsing operation and the reverse operation directly release the motor with regard to the load and remove the motor from stressful conditions, thus contributing to the maintenance of the motor for a longer working life.

In a multi-purpose power tool, both the first and second aspect of the improved operation of the invention may be implemented. In practice, the threshold for the pulsing operation is less then that for the reverse operation.

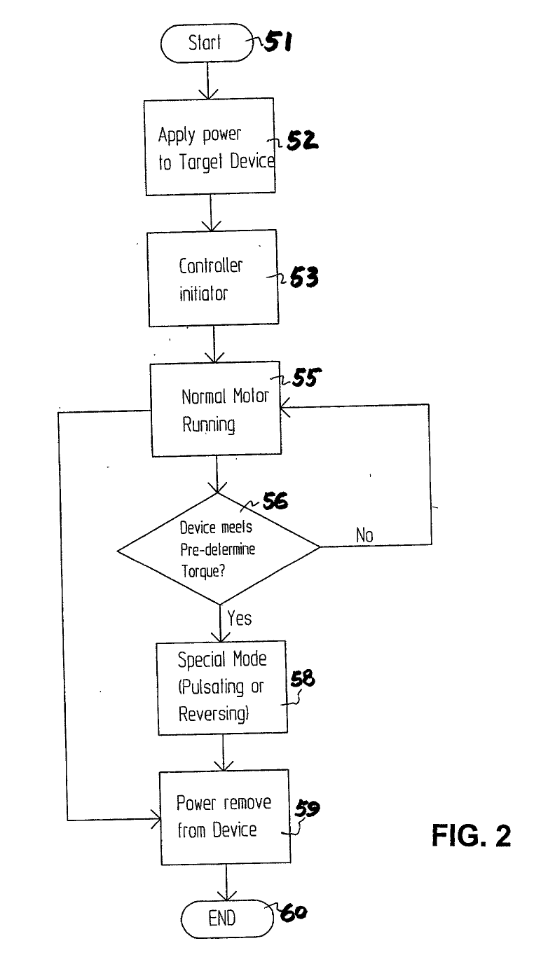

Referring to FIG. 2, start at step 51, power is applied to a target motor driven device at step 52. A controller is also initiated at step 53 for detecting a motor parameter which would be indicative of the value of a load encountered by a motor of the motor driven device. During normal operation, the motor would run in a forward motion uninterrupted. When the motor parameter meets or reaches a predetermined value, for example torque is being measured at step 56, the motor enters into a special mode for an improved operation at step 58, which may either be a pulsing operation or a reverse operation, depending on the measured value of the motor parameter exceeding a first or a second predetermined value of torque. The improved operation would terminate itself at step 59 after a first or a second predetermined duration, or alternatively by manually removing the power from the device.

The method as described may be practiced in a controller as described, or in a motor driven device comprising a motor and the controller as described. Further, the controller as described may preferably include an integrated circuit or processor for controlling the operation of a motor.

Separately, the present invention may also be practiced together with other controllers, for example, a power tool speed controller as described and disclosed in GB 2,314,980 which is now fully incorporated herein by reference.

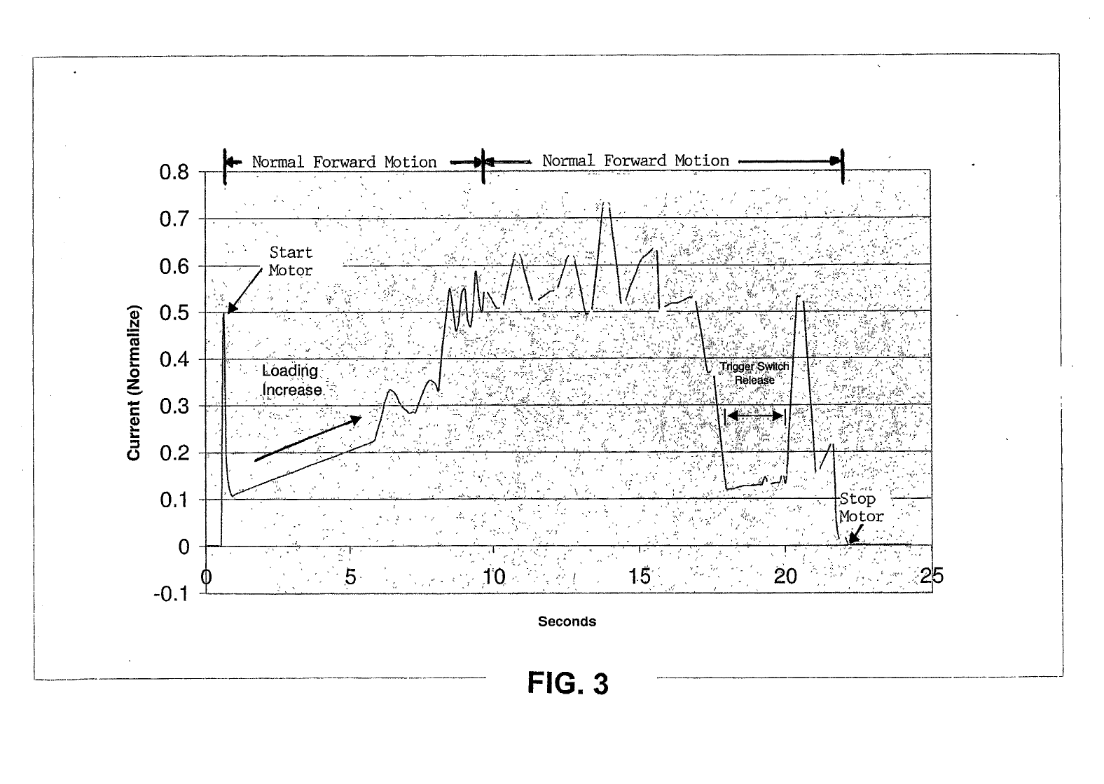

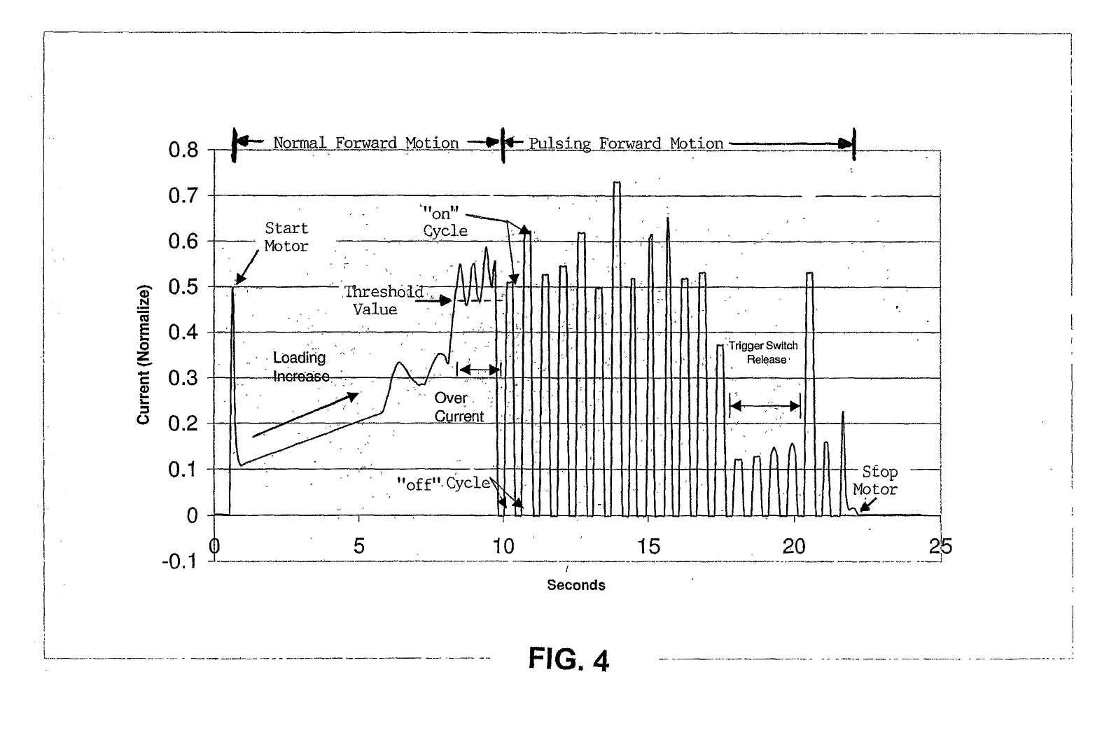

Referring to FIGS. 3 and 4, the graphs represent a power drill operation. FIG. 3 is without the improvement of the invention and FIG. 4 displays a pulsing operation of the invention. Both graphs show the motor current as a function of time and the motor current is substantially proportional to the load being encountered by the motor.

At the start-up of normal forward motion or normal motor operation, a surge of current is required. As the drill operation continues, the load increases and small peaks or rises in current start to appear. When the drill encounters obstacles, the load (and current) increases substantially reaching and exceeds a threshold value. When the drill operation is completed, a reduction of the current appears and the current is then removed from the motor as trigger switch of the device is released.

Comparing FIG. 3 and FIG. 4, when the current reaches and exceeds the threshold value for an over current period, the motor enters into pulsing operation or pulsing forward motor with the current being applied at a predetermined “on” and “off” cycle frequency until the current is removed from the motor manually by means of the trigger switch release.

In FIG. 4, during the pulsing forward motion, the current still attains the normal operation current value during each “on” cycle of the predetermined “on” and “off” cycle frequency and the motor thus is able to operate with normal power and torque during each “on” cycle without resulting any significant adverse effect.

It would be further appreciated that the invention as described is also applicable to safeguard problems associated with motor burnt-out or over-heated due to extended or prolonged use of the power tool. Conveniently, the motor parameter being detected would be the heat intensity generated by the motor coil.

While the principles of the invention have been described above in connection with specific apparatuses and methods, it is to be clearly understood that this description is made only by way of example and not as limitation on the scope of the invention.

What is claimed is:

1. A controller for a motor driven device comprising a motor that draws a current from a power supply to induce a forward motion in response to a load, said controller being adapted to be connected to said motor and to detect a motor parameter indicative of the value of said load, said controller being further adapted to pulse said current “on” and “off” at a first predetermined cycle frequency when the value of said motor parameter exceeds a first predetermined value for a first predetermined period, each “on” cycle of said first predetermined cycle frequency being of sufficient duration to allow said motor to draw sufficient current in response to said load.

2. A controller according to claim 1, wherein each “on” cycle of the first predetermined cycle frequency is of sufficient duration to maintain sufficient current to the motor to normalize the forward motion.

3. A controller according to claim 1, wherein each “off” cycle of the first predetermined cycle frequency is of sufficient duration to allow the motor to be substantially released from the forward motion.

4. A controller according to claim 1, wherein the duration of each “on” cycle or each “off” cycle of the first predetermined cycle frequency ranges from 0.1 second to 13 seconds.

5. A controller according to claim 1, wherein the power supply is a limited DC source.

6. A controller according to claim 1, wherein the controller is adapted to pulse the current “on” and “off” for a first predetermined duration.

7. A controller according to claim 1, wherein the controller is adapted to pulse the current “on” and “off” until the controller is re-set by manually cutting off the power supply to the motor.

8. A controller according to claim 1, wherein the motor has a reverse motion and the controller is adapted to release the motor from said forward motion and induce the motor to said reverse motion when the value of said motor parameter exceeds a second predetermined value for a second predetermined period, said second predetermined value being greater than said first predetermined value.

9. A controller according to claim 8, wherein the controller is adapted to induce the motor to the reverse motion for a second predetermined duration.

10. A controller according to claim 8, wherein the controller is adapted to induce the motor to the reverse motion until the controller is re-set by manually cutting off the power supply to the motor.

11. A controller according to claim 8, wherein the power supply is a limited DC source.

12. A controller for a motor driven device comprising a motor that draws a current from a power supply to induce a forward motion in response to a load, said controller being adapted to be connected to the motor and to detect a motor parameter indicative of the value of said load, said controller being further adapted to release the motor from said forward motion and induce the motor to a reverse motion for a predetermined duration when the value of said motor parameter exceeds a predetermined value for a predetermined period.

13. A motor driven device, comprising
a motor that draws a current from a power supply to induce a forward motion in response to a load, and
a controller connected to the motor and for detecting a motor parameter indicative of the value of the load and for pulsing the current “on” and “off” at a first predetermined cycle frequency when the value of the motor parameter exceeds a first predetermined value for a first predetermined period, each “on” cycle of the first predetermined cycle frequency being of sufficient duration to allow the motor to draw sufficient current in response to the load.

14. A motor driven device according to claim 13, wherein each “on” cycle of the first predetermined cycle frequency is of sufficient duration to maintain sufficient current to the motor to normalize the forward motion.

15. A motor driven device according to claim 13, wherein each “off” cycle of the first predetermined cycle frequency is of sufficient duration to allow the motor to be substantially released from the forward motion.

16. A motor driven device according to claim 13, wherein the motor has a reverse motion and the controller is adapted to release the motor from the forward motion and induce the motor to the reverse motion when the value of the motor parameter exceeds a second predetermined value for a second predetermined period, said second predetermined value being greater than said first predetermined value.

17. A motor driven device according to claim 13, further comprising a battery as source of the power supply.

18. A motor driven device, comprising
a motor that draws a current from a power supply to induce a forward motion in response to a load, and
a controller connected to the motor and for detecting a motor parameter indicative of the value of the load and for releasing the motor from the forward motion and inducing the motor to a reverse motion for a predetermined duration when the value of the motor parameter exceeds a predetermined value for a predetermined period.

19. A motor driven device according to claim 13, further comprising a battery as source of the power supply.

20. A method of controlling a motor driven device having a motor that draws a current from a power supply to induce a forward motion in response to a load, said method comprising:
detecting a motor parameter indicative of the value of the load, and
pulsing the current “on” and “off” at a first predetermined cycle frequency when the value of said motor parameter exceeds a first predetermined value for a first predetermined period, each “on” cycle of said first predetermined cycle frequency being of sufficient duration to allow the motor to draw sufficient current in response to the load.

21. A method according to claim 20, wherein each “on” cycle of the first predetermined cycle frequency is of sufficient duration to maintain sufficient current to the motor to normalize the forward motion.

22. A method according to claim 20, wherein each “off” cycle of the first predetermined cycle frequency is of sufficient duration to allow the motor to be substantially released from the forward motion.

23. A method according to claim 20, wherein the duration of each “on” cycle of the first predetermined cycle frequency ranges from 0.1 second to 13 seconds.

24. A method according to claim 20, wherein the current is pulsed “on” and “off” for a first predetermined duration.

25. A method according to claim 20, wherein the current is pulsed “on” and “off” until the current is re-set by manually cutting off the power supply to the motor.

26. A method according to claim 20, wherein the power is supplied from a limited DC source.
